(19) United States
(12) Patent Application Publication
(10) Pub. No.: US 2005/0149960 A1
(43) Pub. Date: Jul. 7, 2005

(54) Apparatus for driving optical head

(75) Inventor: Hsin-Ming Pu, Tai-Chung (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MUSTEK SYSTEMS INC.

(21) Appl. No.: 10/746,656

(22) Filed: Dec. 29, 2003

(51) Int. Cl. G11B 7/08; G11B 7/085; G11B 7/09

(52) U.S. Cl. 720/664

(57) ABSTRACT

The present invention discloses a sled mechanism for the optical pick-up head, which utilized a drive motor to drive a worm to make a worm wheel rotate. After driven by the worm, the worm wheel will drive a spur gear, which is engaged with a rack and drive the rack forward and backward, and then move the optical pickup head attached to the rack to the right position. In the meanwhile, a set of spring unit is utilized to compensate the tolerance of the components of the gear set.

### BACKGROUND OF THE INVENTION

1. Field of the Invention

The present invention relates to a sled mechanism, which utilizes a set of springs near the optical pickup head. With this set of springs attached to the rack where the pickup head is, the rack and the gear set driven by drive motor can be engaged with each other more tightly. As a result, the tolerance limit can be higher because this design can compensate part of the tolerance. Moreover, the present invention can also improve the yield rate of the mass production, because the slim spindle of disc drive needs high precision accuracy and the present invention is to compensate part of the tolerance. To sum up, the present invention can increase the tolerance, make the drive motor drive the pickup head more smoothly, and improve the mass production yield, by utilizing a set of springs attached to the rack.

2. Background Description

With the progress of high technology and the advancement of optical storage device, more and more multimedia content can be stored in optical disc. The optical disc has advantages of portability, high capacity, low cost, and safety (not easy to be erased or damaged). As the demand for optical disc is rapidly increase, the need for optical drives, CD, CD-R, CD-RW, DVDROM, DVD−R/W, DVD+R/W drives, also dramatically grows. Also, to meet the consumers' need for portability, the drives are now smaller, lighter, and slimmer than ever before. There is a problem coming along with this change, the precision accuracy. When the drives are getting lighter and slimmer, the requirement of precision accuracy will be higher. Due to the high requirement of precision accuracy, a severe tolerance limit is important for the sled mechanism of the optical pickup head, especially when the sled mechanism itself is also getting smaller and slimmer along with the drives. Generally speaking, the module of the gears of the sled mechanism should be under 0.3 and the tolerance limit of the gear s of the sled mechanism has to be under 0.025 to meet the requirement. The high standard of requirement affects the yield rate of mass production. To solve this problem, the present invention presents a better solution to increase the mass production yield.

Firstly, referring to the FIG. 1, the conventional design of a sled mechanism comprises a drive 1, a drive motor 2, a worm 3, which is driven by the drive motor, a worm wheel 4, which is engaged with the worm 3 and driven by it, a spur gear, which is attached to the worm wheel 4 and rotate simultaneously with it, and a rack 6, which is engaged with the spur gear and move forward and backward while the spur gear is rotating counterclockwise and clockwise respectively. As shown in FIG. 1, the drive motor 2 drives a worm 3 to make the worm wheel 4 rotate. After driven by the worm 3, the worm wheel 4 will drive the spur gear 5, which is engaged with the rack 6 and drive the rack 6 forward and backward, and then move the optical pickup head attached to the rack 6 to the right position.

As we can see in the FIG. 1, although the idea of the design is simple, the mass production yield rate is low when there is a severe tolerance limit. When a high precision accuracy of sled mechanism is needed to meet the requirement of slim and light drives, this design is not ideal for mass production.

Another design can surmount the disadvantage. That is, take the worm wheel and spur gear out, and then a drive motor directly drives the optical pickup to move forward and backward by a worm. Because fewer components used, this design can improve the precision accuracy and mass production yield rate.

However, to implement this design, a high-precision and higher-power drive motor is needed, and the cost of it is high. There, although this design solves the problem of tolerance limit and low mass production yield rate, in terms of cost, it is still not ideal for the production for the cost-oriented consumers' products.

### SUMMARY OF THE INVENTION

While there is incompetence in the conventional arts stated in the background of invention above, one of the goals of the present invention is to use a set of springs to compensate the tolerance of the transmission gears, to make the drive motor drive the optical pickup head move more smoothly and prevent the transmission gears from either being stuck because of being engaged too tightly or idle running because of being engaged too loosely.

The other goal is to increase the component tolerance limit to raise the mass production yield rate.

Based on the goals above, the present invention provides a sled mechanism, which comprises: a drive; a drive motor; a worm, which is driven by the drive motor; a worm wheel, which is engaged with the worm 3 and driven by it; a spur gear, which is attached to the worm wheel and rotate simultaneously with it; a rack, which is engaged with the spur gear and move forward and backward while the spur gear is rotating counterclockwise and clockwise respectively; and a flexible unit, which is attached to one side of the rack and is utilized to make the transmission of the sled mechanism smoother.

In the present invention stated above, the worm is driven by the drive motor and drives the worm wheel engaged with it. And the spur gear is mounted on the worm wheel and the gear set of the worm wheel and the spur gear then is connect to the drive.

In the present invention stated above, the flexible unit can be assembly of springs. And one end of these springs is mounted on the drive and the other end is connected to the rack, to make the transmission smoother.

In the present invention stated above, the flexible unit can be a flexible metal shaft used to fix the set of worm wheel and spur gear. And the flexible unit can be a plastic holder used to hold the drive motor.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 presents the conventional sled mechanism of the optical pickup head in a disc drive;

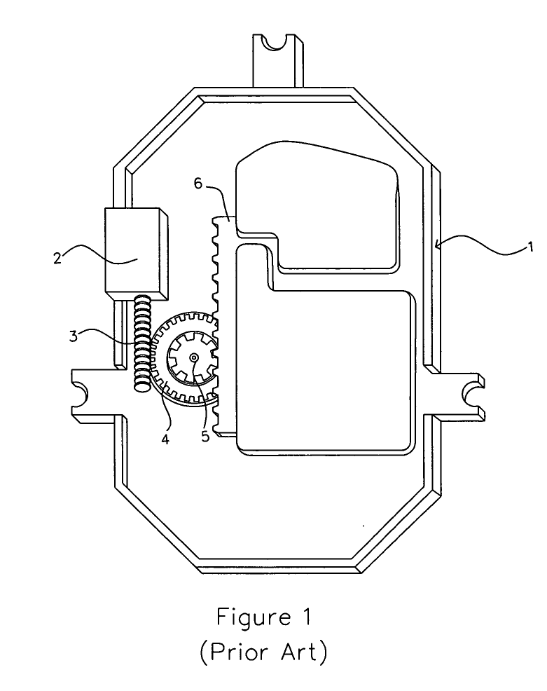

FIG. 2 presents the present invention;

The followings are the list of detailed legends presented in the present invention.

1: a drive
2: a drive motor
3: a worm
4: a worm wheel
5: a spur gear
6: a rack
7: a set of spring

### DETAILED DESCRIPTION OF A PREFERRED EMBODIMENT OF THE INVENTION

The following is a description of the present invention. However, other than the detailed description, the present can also be widely implemented in other embodiment, and the scope of the present invention is not limited and is based on the future patent scope.

Moreover, to provide more detailed description and clearer understanding of the present invention, the figures are not drawn according to the corresponding scale. Some measurement and scale have been exaggerated and some unrelated details are not drawn to make figure concise.

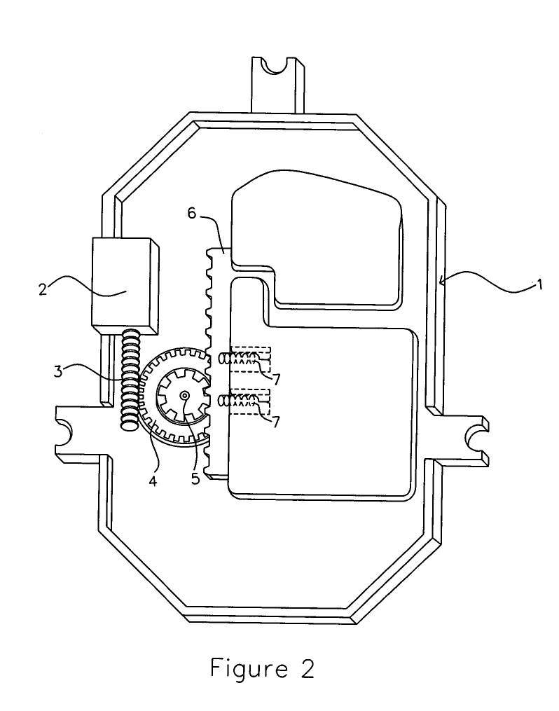

The present invention is illustrated in FIG. 2, the present invention comprises a drive 1, a drive motor 2, a worm 3 which is driven by the drive motor, a worm wheel 4 which is engaged with the worm 3 and driven by it, a spur gear 5 which is attached to the worm wheel 4 and rotate simultaneously with it, a rack 6 which is engaged with the spur gear and move forward and backward while the spur gear is rotating counterclockwise and clockwise respectively, and a set of spring 7 which is attached to one side of the rack and is utilized to make the transmission of the sled mechanism more smooth.

As shown in FIG. 2, the drive motor 2 drives a worm 3 to make the worm wheel 4 rotate. After driven by the worm 3, the worm wheel 4 will drive the spur gear 5, which is engaged with the rack 6 and drive the rack 6 forward and backward, and then move the optical pickup head attached to the rack 6 to the right position. Then a better embodiment is to install a set of spring 7 in the rack 6 near the pickup head. Thus, to compensate the tolerance of the transmission gears and meet the precision accuracy required without sacrificing the mass production yield rate.

In the present invention stated above, the flexible unit can also be either a flexible metal shaft used to fix the set of worm wheel and spur gear or a plastic holder used to hold the drive motor. All the designs above can solve the problem of tolerance and precision accuracy.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. An apparatus for driving an optical head comprises:
a drive;
a drive motor;
a worm driven by said drive motor;
a worm wheel engaged with said worm and driven by said worm;
a spur gear attached to said worm wheel and rotating simultaneously with said worm wheel;
a rack engaged with said spur gear and moving forward and backward while said spur gear is rotating counterclockwise and clockwise respectively; and, an elastic unit attached to one side of said rack, and utilized to make transmission smoother.

2. The apparatus for driving an optical head according to claim 1, wherein said motor is a step-driven motor.

3. The apparatus for driving an optical head according to claim 1, wherein said worm is driven by said drive motor and drives said worm wheel which is engaged with it.

4. The apparatus for driving an optical head according to claim 1, wherein said spur gear is mounted on said worm wheel, and said worm wheel and said spur gear is formed on said drive.

5. The apparatus for driving an optical head according to claim 1, wherein said elastic unit is a spring.

6. The apparatus for driving an optical head according to claim 1, wherein one end of said spring is mounted on said drive and another end of said spring is connected to the rack.

7. The apparatus for driving an optical head according to claim 1, wherein said elastic unit is a flexible metal shaft.

8. The apparatus for driving an optical head according to claim 1, wherein said elastic unit is a plastic holder used to hold said drive motor.
